(19) United States
(12) Patent Application Publication
(10) Pub. No.: US 2026/0080773 A1
(43) Pub. Date: Mar. 19, 2026

(54) ROAD INCIDENT MONITORING AND REPORTING SYSTEM USING ARTIFICIAL INTELLIGENCE AND EDGE COMPUTING

(71) Applicant: Panasonic Automotive Systems America, LLC, Peachtree City, GA (US)

(72) Inventor: SANJEEV DWARKANATH RAO, PEACHTREE CITY, GA (US)

(21) Appl. No.: 19/328,328

(22) Filed: Sep. 15, 2025

Related U.S. Application Data
(60) Provisional application No. 63/694,229, filed on Sep. 13, 2024.

(51) Int. Cl. G08G 1/01; H04W 76/50

(52) U.S. Cl. CPC G08G 1/0133; G08G 1/0141; H04W 76/50

(57) ABSTRACT

A road incident monitoring and reporting system includes a sensing device that collects data indicative of whether an incident has occurred involving a motor vehicle on the road. The sensing device transmits a sensor signal including the data. An electronic processor is communicatively coupled to the sensing device and received the sensor signal. The electronic processor determines, based on the sensor signal, whether the incident has occurred involving a motor vehicle on the road. The electronic processor transmits an incident notification to a response team only if it has been determined that the incident has occurred involving a motor vehicle on the road.

### CROSS-REFERENCE TO RELATED APPLICATIONS

This application claims benefit of U.S. Provisional Application No. 63/694,229, filed on Sep. 13, 2024, the disclosure of which is hereby incorporated by reference in its entirety for all purposes.

### BACKGROUND OF THE INVENTION

### 1. Field of the Invention

The present invention relates to a reporting system in a motor vehicle.

### 2. Description of the Related Art

Highways accidents are potentially fatal and may need automated and immediate notification mechanisms to help first responders save lives. Current systems depend on humans to respond to these incidents and report to emergency services who then make informed decisions to alert first responders.

It is known to use a crash notification application onboard the vehicle to call emergency services. However, such crash notification applications require the vehicle to have an emergency call option. Also, the driver/passenger must press the emergency button, or a functional crash notification sensor must automate the call to emergency services and engage the in-vehicle microphone for communication.

It is also known that people witnessing the accident may manually call emergency services via their cellphone or nearest telephone. However, this requires cell tower reception and the person to report the incident to the emergency team with accuracy for efficient incident management.

In recent times, the vehicles supporting auto-pilot modes have been involved in accidents. A fully perfected autonomous vehicle technology is still under development.

### SUMMARY OF THE INVENTION

The invention may utilize the existing road/highway infrastructure to identify traffic incidents using artificial intelligence (AI) and edge computing technology. The invention may employ AI and edge computing technologies to accelerate a reporting mechanism. By quick identification of road incidents via AI analytics, it is possible to alert and/or deploy response teams without delay.

Incidents may include collisions between vehicles, animals, property, and humans. Incidents may also include acts of terrorism and natural disasters, including floods, fires, earthquakes, sinkholes, fallen electric poles, fallen trees, extremely low visibility conditions, broken bridges, and other dangerous driving conditions, etc.

With the present invention, an alert/standby message may be sent in advance to first responders for faster and more efficient deployment of resources.

The invention comprises, in one form thereof, a road incident monitoring and reporting system including a sensing device that collects data indicative of whether an incident has occurred involving a motor vehicle on the road. The sensing device transmits a sensor signal including the data. An electronic processor is communicatively coupled to the sensing device and received the sensor signal. The electronic processor determines, based on the sensor signal, whether the incident has occurred involving a motor vehicle on the road. The electronic processor transmits an incident notification to a response team only if it has been determined that the incident has occurred involving a motor vehicle on the road.

The invention comprises, in another form thereof, a road incident monitoring and reporting method including collecting data indicative of whether an incident has occurred involving a motor vehicle on the road. A sensor signal including the data is produced. It is determined, based on the sensor signal, whether the incident has occurred involving a motor vehicle on the road. An incident notification is transmitted to a response team only if it has been determined that the incident has occurred involving a motor vehicle on the road.

The invention comprises, in yet another form thereof, a road incident monitoring and reporting system including a sensing device collecting data that is indicative of whether an incident has occurred involving a motor vehicle on the road. The sensing device transmits a sensor signal that is dependent upon the data. An electronic processor is communicatively coupled to the sensing device and receives the sensor signal. The electronic processor determines, based on the sensor signal, whether the incident has occurred involving a motor vehicle on the road. Only if it has been determined that the incident has occurred involving a motor vehicle on the road, the electronic processor transmits an incident notification to a response team. Only if it has been determined that the incident has occurred involving a motor vehicle on the road, the electronic processor transmits an alert signal to emergency responders. The alert signal instructs the emergency responders to be alert for instructions from the response team. The alert signal also informs the emergency responders of a higher-than-normal, increased, or relatively high probability that the emergency responders will receive instructions from the response team within the following few minutes.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a road incident monitoring and reporting system of the present invention.

FIG. 2 is a flow chart of one embodiment of a road incident monitoring and reporting method of the present invention for a motor vehicle.

FIG. 3 is a flow chart of another embodiment of a road incident monitoring and reporting method of the present invention for a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

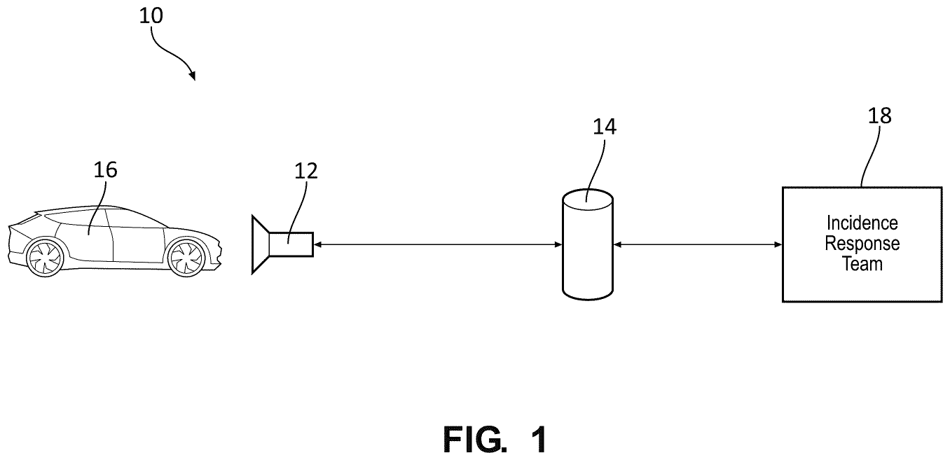

FIG. 1 illustrates one embodiment of a road incident monitoring and reporting system 10 of the present invention, including an incident-monitoring internet-of-things (IoT) sensor device 12 in bi-directional communication with an edge computing artificial intelligence (AI) platform 14 performing real-time AI analytics.

AI platform 14 may include an electronic processor and may be trained with machine learning on sensor data from previous incidents such that platform 14 can determine from real-time data whether an incident has occurred in the previous five seconds or so.

Device 12 may be a camera, microphone, temperature sensor, or other device that is capable of detecting an incident involving a vehicle on a road and/or that occurs near a vehicle. Device 12 may be mounted on a pole or traffic light, for example, that is near an intersection of roads, or some other place with a relatively high likelihood of incidents.

During use, incident-monitoring IoT device 12 and platform 14 detect that a motor vehicle 16 has been involved in an incident. The incident in which vehicle 16 has been involved may include the vehicle colliding into another vehicle or thing, or the vehicle being near some dangerous driving condition, for example. If device 12 is a camera, the camera may capture images of vehicle 16 and transmit the captured images to platform 14. Platform 14 may analyze the captured images to determine when vehicle 16 has been involved in an incident. If device 12 is a temperature sensor, the temperature sensor may record air temperatures near vehicle 16 and transmit the recorded temperature data to platform 14. Platform 14 may analyze the temperature data to determine when vehicle 16 has been involved in an incident. High temperature data may indicate that vehicle 16 is on fire or is near a fire, for example.

Upon determining that vehicle 16 has been involved in an incident, platform 14 may transmit a signal that is indicative of the incident to an incidence response team 18. Team 18 may include policemen, firemen, and ambulance emergency medial technicians, for example. The signal transmitted from platform 14 to team 18 may include information about the time and place of the incident, as well as captured images of the incident and vehicle 16 and/or microphone signals produced during the incident. The signal may also indicate whether there is a high likelihood of a fire in or near vehicle 16, as indicated by the temperature data.

Analytics platform 14 may make other determinations that may be included in the signal to team 18. Such determinations may include whether vehicle 16 is on fire, whether any passengers have been thrown from vehicle 16, and/or the likely extent of injuries of the passengers based on images of previous similar incidents.

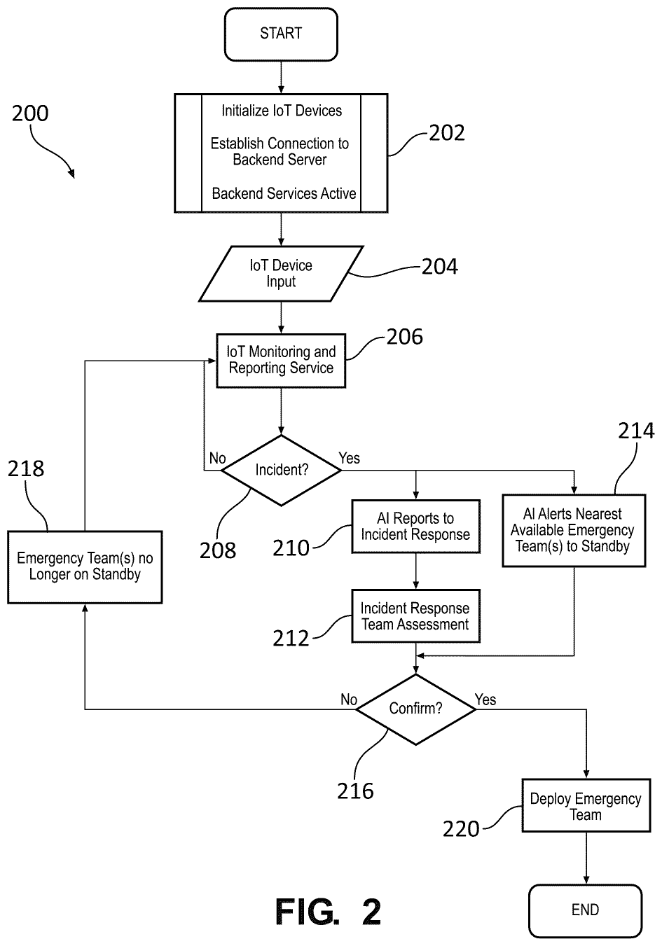

FIG. 2 illustrates one embodiment of a road incident monitoring and reporting method 200 of the present invention for a motor vehicle. In a first step 202, IoT devices 12 are initialized and connected to a backend server in analytics platform 14. The backend services of analytics platform 14 become active.

In a next step 204, inputs are received from the IoT device. For example, analytics platform 14 may receive inputs in the form of captured images from an IoT device in the form of a camera.

Next, in step 206, IoT device monitoring and reporting is performed. For example, analytics platform 14 may analyze the captured images and determine therefrom whether a motor vehicle in the images has been involved in an incident that calls for human responders to come to the scene of the incident.

In step 208, if it is determined that there has been no incident, then operation returns to step 206. However, if it is determined in step 208 that there has been an incident, then operation proceeds to step 210 where AI platform analytics 14 reports the incident to response team 18. For example, AI platform analytics 14 may send a signal to response team 18 informing team 18 about the incident. The signal from AI platform analytics 14 to team 18 may include the captured images.

Then, in step 212, an assessment of the reported incident is made by response team 18. For example, humans on the response team may look at the captured images and make their own determination about how best to respond to the incident.

If it is determined in step 208 that there has been an incident, then operation also proceeds to step 214 where AI platform analytics 14 alerts the nearest available emergency team(s) to standby for instructions from response team 18 while response team 18 assesses and evaluates the incident as reported to response team 18 by AI platform analytics 14. As shown in FIG. 2, step 214 may operate in parallel time-wise with steps 210, 212.

After steps 212 and 214, response team 18 makes a decision in step 216 as to whether there is a true and actual incident requiring attention from the emergency team. If it is decided that there is not a true and actual incident, then operation proceeds to step 218 where response team 18 informs the emergency team(s) that they should no longer be on the standby condition on which they were instructed to be in step 214. Operation then returns to step 206.

If, on the other hand, it is decided in step 216 that there is a true and actual incident, then operation proceeds to step 220 where response team 18 deploys the emergency team(s) to the scene of the incident.

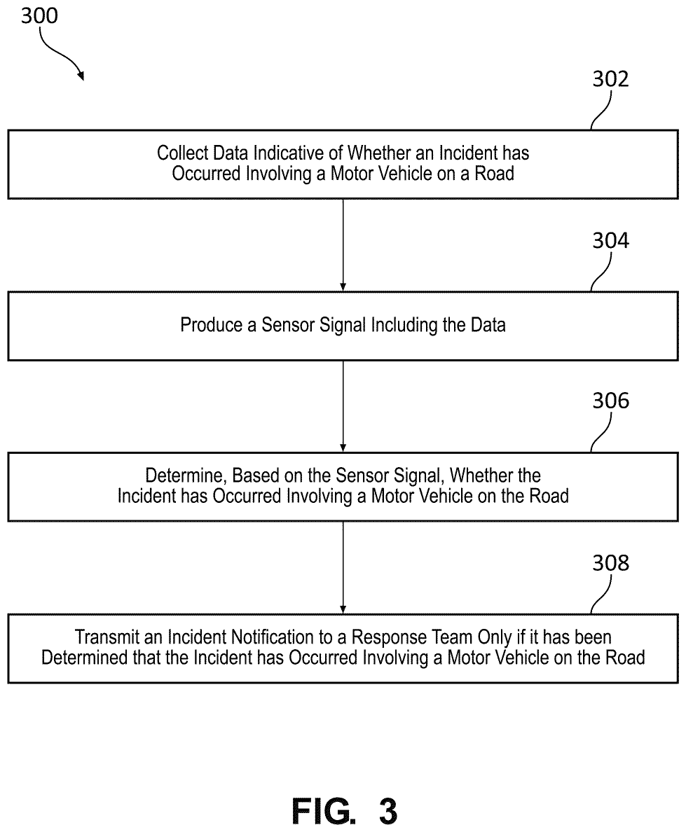

FIG. 3 illustrates another embodiment of a road incident monitoring and reporting method 300 of the present invention for a motor vehicle. In a first step 302, data indicative of whether an incident has occurred involving a motor vehicle on the road is collected. For example, an IoT device 12 in the form of a camera may capture images of motor vehicle 16 on the road.

Next, in step 304, a sensor signal including the data is produced. For example, IoT device 12 may produce a signal that may include captured images of the incident and vehicle 16.

In a next step 306, it is determined, based on the sensor signal, whether the incident has occurred involving a motor vehicle on the road. For example, platform 14 may receive the sensor signal and analyze the captured images to determine whether vehicle 16 has been involved in an incident.

In a final step 308, an incident notification is transmitted to a response team only if it has been determined that the incident has occurred involving a motor vehicle on the road. For example, upon determining that vehicle 16 has been involved in an incident, platform 14 may transmit a signal that is indicative of the incident to an incidence response team 18.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A road incident monitoring and reporting system, comprising:
a sensing device configured to:
collect data indicative of whether an incident has occurred involving a motor vehicle on the road; and
transmit a sensor signal including the data; and
an electronic processor communicatively coupled to the sensing device and configured to:
receive the sensor signal;
determine, based on the sensor signal, whether the incident has occurred involving a motor vehicle on the road; and
transmit an incident notification to a response team only if it has been determined that the incident has occurred involving a motor vehicle on the road.

2. The system of claim 1 wherein the sensing device includes a camera.

3. The system of claim 2 wherein the sensing device includes a microphone.

4. The system of claim 1 wherein the incident comprises a collision between the motor vehicle and another thing.

5. The system of claim 1 wherein the electronic processor is configured to use artificial intelligence analytics to determine whether the incident has occurred involving a motor vehicle on the road.

6. The system of claim 5 wherein the artificial intelligence analytics has been trained on sensor signals associated with previous motor vehicle incidents.

7. The system of claim 1 wherein the electronic processor is configured to transmit an alert signal to emergency responders only if it has been determined that the incident has occurred involving a motor vehicle on the road, the alert signal informing the emergency responders of an increased probability that the emergency responders will receive instructions from the response team within the following three minutes.

8. A road incident monitoring and reporting method, comprising:
collecting data indicative of whether an incident has occurred involving a motor vehicle on the road;
producing a sensor signal including the data;
determining, based on the sensor signal, whether the incident has occurred involving a motor vehicle on the road; and
transmitting an incident notification to a response team only if it has been determined that the incident has occurred involving a motor vehicle on the road.

9. The method of claim 8 wherein the collecting is performed by a camera.

10. The method of claim 9 wherein the collecting is also performed by a microphone.

11. The method of claim 8 wherein the incident comprises a collision between the motor vehicle and another thing.

12. The method of claim 8 wherein the determining includes using artificial intelligence analytics to determine whether the incident has occurred involving a motor vehicle on the road.

13. The method of claim 12 wherein the artificial intelligence analytics has been trained on sensor signals associated with previous motor vehicle incidents.

14. The method of claim 8 further comprising transmitting an alert signal to emergency responders only if it has been determined that the incident has occurred involving a motor vehicle on the road, the alert signal informing the emergency responders of an increased probability that the emergency responders will receive instructions from the response team within the following three minutes.

15. A road incident monitoring and reporting system, comprising:
a sensing device configured to:
collect data indicative of whether an incident has occurred involving a motor vehicle on the road; and
transmit a sensor signal that is dependent upon the data; and
an electronic processor communicatively coupled to the sensing device and configured to:
receive the sensor signal;
determine, based on the sensor signal, whether the incident has occurred involving a motor vehicle on the road; and
only if it has been determined that the incident has occurred involving a motor vehicle on the road:
transmit an incident notification to a response team only if it has been determined that the incident has occurred involving a motor vehicle on the road; and
transmit an alert signal to emergency responders, the alert signal informing the emergency responders of a higher-than-normal probability that the emergency responders will receive instructions from the response team within the following five minutes.

16. The system of claim 15 wherein the sensing device includes a camera.

17. The system of claim 16 wherein the sensing device includes a microphone.

18. The system of claim 15 wherein the incident comprises a collision between the motor vehicle and another thing.

19. The system of claim 15 wherein the electronic processor is configured to use artificial intelligence analytics to determine whether the incident has occurred involving a motor vehicle on the road.

20. The system of claim 19 wherein the artificial intelligence analytics has been trained on sensor signals associated with previous motor vehicle incidents.
